(19) United States
(12) Patent Application Publication
(10) Pub. No.: US 2004/0064625 A1
(43) Pub. Date: Apr. 1, 2004

(54) Processor system containing CPU core

(75) Inventor: Atsushi Date, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/671,785

(22) Filed: Sep. 29, 2003

(30) Foreign Application Priority Data
Sep. 30, 2002 (JP) 2002-286049

(51) Int. Cl. G06F 13/14

(52) U.S. Cl. 710/305

(57) ABSTRACT

For an LSI generated on a single semiconductor substrate, a built-in CPU core, a memory controller, an external bus interface that can connect an external CPU chip from outside of the single semiconductor substrate, and a system bus bridge that mutually connects the built-in CPU core, the memory controller and the external bus interface are provided, so that the system structure can flexibly be changed by adding or exchanging an external CPU chip according to required performance.

### BACKGROUND OF THE INVENTION

1. Field of the Invention

This invention relates to a processor system that is composed of a system LSI containing CPU cores and the like.

2. Related Background Art

Conventionally, as an LSI containing CPU cores, an LSI shown in FIG. 4 in Japanese Patent Application Laid-Open No. H11-45225 is proposed.

In FIG. 4, a CPU core 401 built in the LSI is connected to SystemBusBridge 404 through a CPU bus 403. The SystemBusBridge 404 is a crossbar switch, and a memory controller 402, Gbus 406 and IObus 405 are connected to the SystemBusBridge 404 besides the CPU bus 403. A bus arbiter 411, a printer interface 412 and a scanner interface 413 are connected to the Gbus406, and a bus arbiter 410, a power management unit 407, an interrupt controller 408, UART 409 and other components are connected to the IObus 405, comprising a controller for a complex apparatus.

In addition, an LSI containing a plurality of CPU cores is also proposed. Furthermore, an LSI not containing a CPU core but having an interface for CPU bus is also proposed.

The conventional LSI containing CPU cores, generally, does not require an independent discrete CPU, so that the LSI has the advantage that it can comprise an apparatus at low cost. However, the LSI has a problem that processing capability of the CPU core is lower than the latest discrete CPU. To solve the problem, by containing a plurality of CPU cores and adopting parallel processing, an LSI having improved processing capability also exists. In the case of these LSIs, if performance of a built-in CPU core falls, the LSI must be re-designed and remanufactured.

On the other hand, there is a problem that the latest discrete CPU is expensive and it cannot be used for low-performance models. In addition, there is another problem, in which if an LSI not containing a CPU core is used, CPU must be provided outside, so that the price of the system becomes high if the system can be satisfied with processing performance of a containable CPU core.

### SUMMARY OF THE INVENTION

The purpose of this invention is to provide a flexible structure processor system, which can be comprised at low cost if low processing performance is accepted and the structure of which is simply changed if high processing performance is required.

According to one aspect, the present invention that achieves these objectives relates to a processor system, which is provided with a built-in processor, a memory controller, an external bus interface that can connect an external processor from outside of a single semiconductor substrate, and a connection unit that mutually connects the built-in processor, the memory controller and the external bus interface on the single semiconductor substrate.

Other objectives and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a block diagram to show a structure of an LSI in an embodiment;

FIG. 2 is a figure to explain a structure added with Enable signals;

FIG. 3 is a figure to show an embodiment using a common bus; and

FIG. 4 is a figure to show a conventional system structure.

### DESCRIPTION OF THE PREFERRED EMBODIMENTS

Hereinafter, with reference to attached drawings, preferred embodiments according to this invention will be explained in detail.

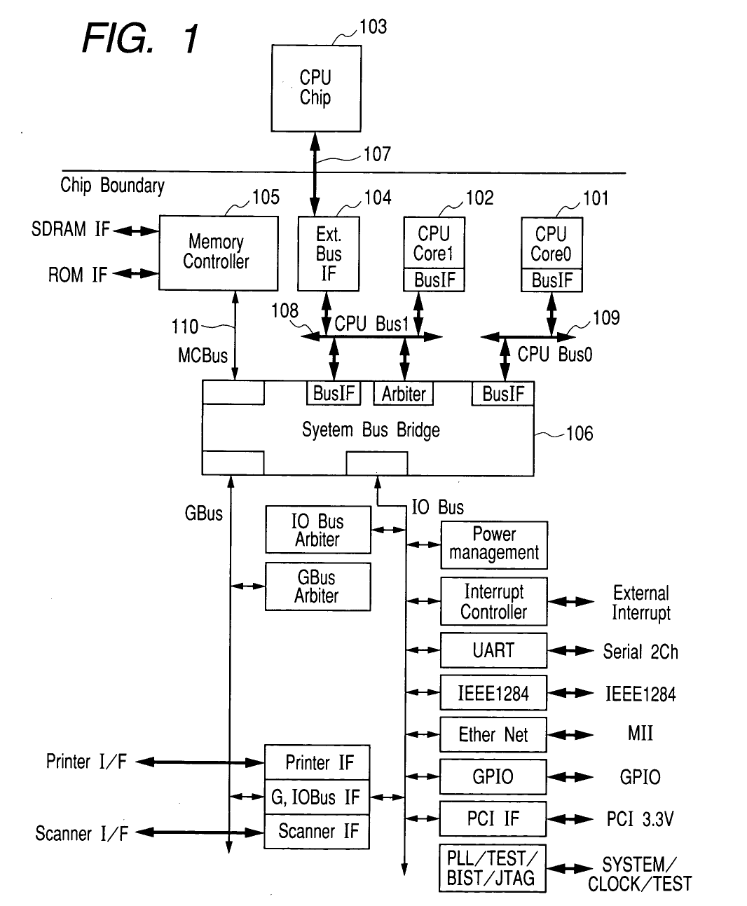

FIG. 1 shows a block diagram of a system structure example adapted in this invention.

In a chip, a first CPU core 101, a CPU bus 109 connected to the first CPU core 101, a second CPU core 102 and a CPU bus 108 connected to the second CPU core 102 are provided, and Ext.BusIF 104, which is an external bus interface, is connected to the CPU bus 108. The specifications of an external CPU bus 107 supported by the Ext.BusIF 104 do not restrict this invention, but they are desirable to be able to connect a CPU that adopts the same architecture as internal CPU cores. In this embodiment, a bus, which can connect a CPU based on MIPS architecture, is adopted.

An external CPU 103 is connected from the LSI outside through the CPU bus 107.

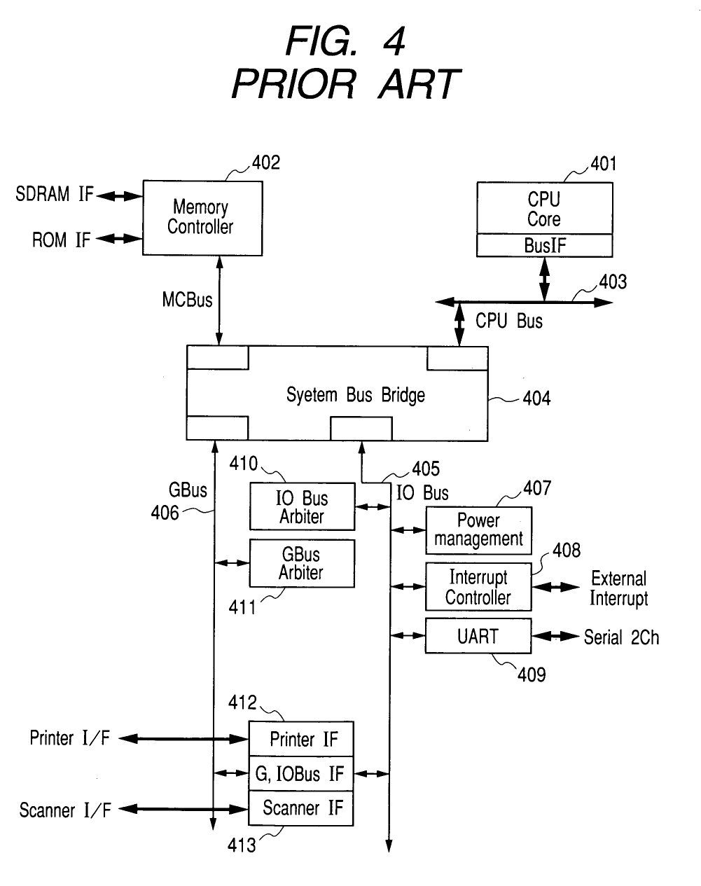

A memory controller 105 controls SDRAM in the LSI outside. SystemBusBridge 106 mutually connects the abode-described CPU buses 108 and 109, MCBus 110, which is a connection bus of the memory controller 105, GBus and IOBus. As in the same as FIG. 4, a bus arbiter, a printer interface and a scanner interface are connected to the GBus, and the bus arbiter, a power management unit, an interactive controller, UART and others are connected to the IOBus to comprise a controller of a complex apparatus.

In this embodiment, after reset release of the LSI, the CPUCore0 (101), the CPUCore1 (102) and the external CPU 103 begin execution of boot programs simultaneously from a boot section of ROM connected with the memory controller 105. Since each processor is stored with hard-wired, determined CPUID, an initial routine common to each processor is executed, and then each individual program is performed. This allows three processors to be used at the same time. This method has already been known in multi-processor systems using a plurality of CPU chips.

In such a structure, by connecting higher performance CPU as the external CPU 103 if required, performance can be improved. On the other hand, in a system, which is not required with high performance, the external CPU 103 is not mounted, the external CPU bus 107 is fixed at an appropriate level, and programs are executed using only two internal CPU. With this method, a cheap system can be realized. In this embodiment, by fixing a signal, which determines availability or non-availability of the external CPU bus 107, and ValidOut_L signal to H level, the only internal CPUs are used when an external CPU is not connected.

Alternatively, although two internal CPUs are used in this embodiment, only one internal.CPU may also be used.

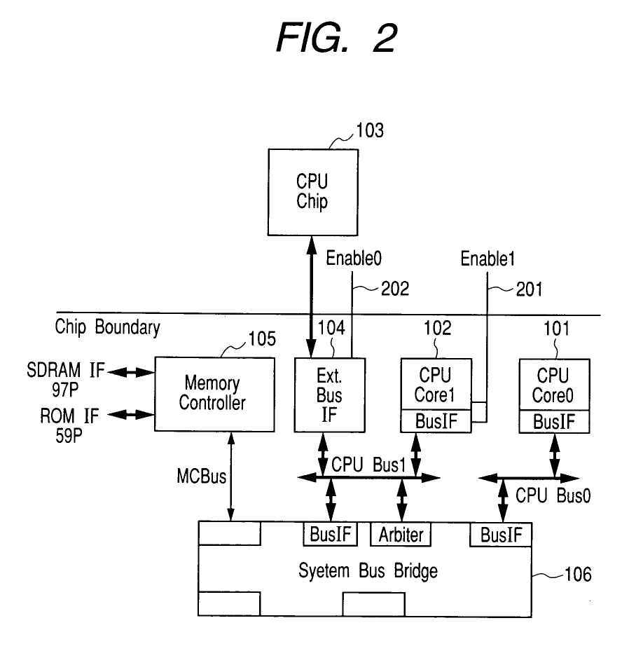

FIG. 2 shows another embodiment according to this invention. In this invention, an Enable0 signal 202 and an Enable1 signal 201 are added to the above-described embodiment.

The Enable0 signal is connected to the Ext.BusIF 104, and ORed with a reset signal internally. If this signal is asserted, the Ext.BusIF 104 is in the same condition as reset, and does not issue a request for the right-to-use of bus for the CPUBus1 (108). In addition, the Enable1 signal 201 is connected to the CPUCore1 (102) and a bus interface circuit built in the CPUCore1 (102), and the CPUCore1 does not issue a request for the right-to-use of bus for the CPUBus1 (108).

That is, if the Enable0 signal (202) is deasserted and the Enable1 signal (201) is asserted, the CPUCore1 (102) can use the CPUBus1 (108) monopolistically. On the other hand, the Enable0 signal (202) is asserted and the Enable1 signal (201) is deasserted, the external CPU 103 can use the CPUBus1 (108) monopblistically. In addition, in this embodiment, CPUS, which have the same architecture, are adopted for the internal CPU core and the external CPU, so that common programs stored in ROM can be used for both internal and external CPUs.

This can simply improve performance by adding external CPUs. In addition, a plurality of systems, which have different processing performance, can be realized using common LSI and programs.

In addition, in this embodiment, the Ext.BusIF 104 and the CPUCore1 (102) are connected to the same CPU bus (CPUBus1) 108, so that the number of bus connection ports of the SystemBusBridge 106 can be reduced to realize reduction of circuit scale and low pricing of LSI.

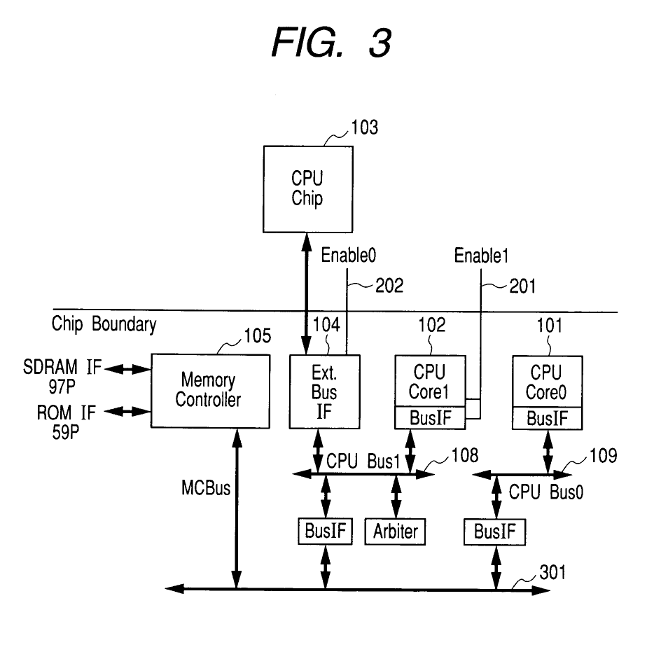

FIG. 3 shows another embodiment. In this embodiment, instead of the SystemBusBridge 106, SystemBus 301 is adopted. If a bus is used instead of a crossbar switch and CPU, which can acquire the right-to-use for the CPUCore0 (101) and the CPUBus1 (108), accesses separate slave buses (MCBus, GBus or IOBus) at the same time, simultaneous connection cannot be performed and performance is lowered. However, an area, which is required to realize a circuit, becomes small, so that a cheaper LSI can be constituted.

In the above-described embodiments, for an apparatus that requires high processing performance, high performance is easily acquired by connecting a processor outside of a semiconductor substrate besides an internal processor on the substrate, and for an apparatus that does not require high processing performance, only an internal processor on a semiconductor substrate is used without using an external processor. This can realize low pricing and a flexible system structure according to purpose.

In addition, the adaptation range of the same semiconductor substrate is extended from a low performance apparatus to a high performance apparatus. Furthermore, the necessity for re-design of a substrate is reduced in the case of that shortage of processing performance occurs, so that mass production becomes possible and low pricing can be realized by mass production effects.

Although the present invention has been described in its preferred form with a certain degree of particularity, many apparently widely different embodiments of the invention can be made without departing from the spirit and the scope thereof. It is to be understood that the invention is not limited to the specific embodiments thereof except as defined in the appended claims.

What is claimed is:

1. A processor system, which is provided with a built-in processor, a memory controller, an external bus interface that can connect an external processor from outside of a single semiconductor substrate, and a connection unit that mutually connects the built-in processor, the memory controller and the external bus interface on the single semiconductor substrate.

2. The processor system according to claim 1, wherein the connection unit includes a crossbar switch.

3. The processor system according to claim 1, wherein the connection unit includes a common bus.

4. The processor system according to claim 1, further comprising:
a second built-in processor connected to the connection unit on the semiconductor substrate.

5. The processor system according to claim 1, comprising:
enabling means for enabling either the built-in processor or the external bus interface.

6. The processor system according to claim 5, wherein the enabling means enables the built-in processor and the external bus interface independently, respectively.

7. The processor system according to claim 1, wherein the built-in processor and the external bus interface are connected through a bus common to the connection unit.

8. The processor system according to claim 1, wherein the built-in processor and the external processor use in common programs stored in memory controlled by the memory controller.

9. The processor system according to claim 1, further comprising:
an image data transfer bus connected with the connection unit; and
an image output device interface or an image input device interface connected with the image data transfer bus on the semiconductor substrate.
